(19) United States
(12) Patent Application Publication
(10) Pub. No.: US 2026/0084642 A1
(43) Pub. Date: Mar. 26, 2026

(54) SIDE AIRBAG DEVICE FOR VEHICLE

(71) Applicants: Yuto KOBAYASHI, Kanagawa (JP); Takaki SHIBUYA, Kanagawa (JP); Autoliv Development AB, Vargarda (SE)

(72) Inventors: Yuto KOBAYASHI, Kanagawa (JP); Takaki SHIBUYA, Kanagawa (JP)

(21) Appl. No.: 18/994,985

(22) PCT Filed: Jul. 10, 2023
(86) PCT No.: PCT/JP2023/025412

§ 371 Date: Dec. 16, 2025

(30) Foreign Application Priority Data
Jul. 15, 2022 (JP) 2022-114208

(51) Int. Cl. B60R 21/207; B60R 21/231; B60R 21/233

(52) U.S. Cl. CPC B60R 21/207; B60R 21/23138; B60R 21/233; B60R 2021/23146; B60R 2021/23324

(57) ABSTRACT

An airbag cushion of a side airbag device has a pre-push chamber that initially receives gas from an inflator, and a main chamber that receives gas from the pre-push chamber. The pre-push chamber has a pre-upper chamber aligned with a seat back and a pre-lower chamber aligned with a seat cushion. A main chamber has a main upper chamber connected to the pre-upper chamber via a first inner vent, a main lower chamber connected to the pre-lower chamber via a check valve, and a baffle demarcating the upper main chamber and the lower main chamber.

### CROSS-REFERENCE TO RELATED APPLICATIONS

This application is a National Stage of International Application No. PCT/JP2023/025412, filed Jul. 10, 2023, which claims priority to Japanese Application No. 2022114208, filed Jul. 15, 2022. The entire disclosures of each of the above applications are incorporated herein by reference.

### FIELD

The present invention relates to a vehicular side airbag device for restraining an occupant seated in a vehicle seat.

### BACKGROUND

Airbag devices have generally become standard equipment in vehicles in recent years. An airbag device is a safety device which is operated in the event of an emergency such as a vehicle collision, retaining and protecting occupants utilizing an airbag cushion which expands and deploys based on gas pressure.

There are various types of airbag devices depending on the installation site and application. For example, in the vehicle side airbag device disclosed in Patent Document 1 by the present applicant, the airbag cushion expands and deploys from the side of the seat into the gap between the occupant and the side of the vehicle, enabling restraint of the occupant from the side. In particular, the side airbag 4 in Patent Document 1 has a partition member 7 provided inside, which allows the thickness to be varied depending on the part, making it possible to appropriately restrain the skeletal strong chest and waist areas as well as the weak abdominal area, respectively.

### RELATED ART DOCUMENTS

### Patent Documents

Patent Document 1: International Patent Publication No. 2014/123055

### SUMMARY

### Problem to be Solved by the Invention

Currently, there is demand for further improvement in occupant restraining performance of airbag cushions of vehicular side airbag devices. This can be effectively achieved by starting to restrain the occupant from an early stage of the airbag cushion expanding and deploying, and to restrain the occupant while suppressing the amount of movement of the occupant from the seat.

In light of the foregoing, an object of the present invention is to provide a vehicular side airbag device that is capable of improving occupant restraint performance with a simple structure.

### Means for Solving the Problem

In order to resolve the problem described above, a vehicular side airbag device according to the present invention is a vehicular side airbag device having an airbag module that can be attached in a side frame of a seat back of a vehicle seat,
the airbag module comprising: an airbag cushion that is rolled or folded in a prescribed storage form and attached in the side frame; and an inflator attached to the side frame in a state of being inserted into the airbag cushion; the airbag cushion comprising: a pre-push chamber which is the first to receive gas from the inflator and expands and deploys; and a main chamber that receives gas passing through the pre-push chamber and expands and deploys; the pre-push chamber comprising: a pre-upper chamber extending in a vertical direction along the seat back; and a pre-lower chamber extending forward from a lower part of the pre-upper chamber along a seat cushion of the vehicle seat; the main chamber comprising: a main upper chamber provided in an area overlapping the pre-upper chamber as viewed from a side of the vehicle seat; a main lower chamber provided below the main upper chamber in an area overlapping the pre-lower chamber; and a baffle or stitching that partitions the main upper chamber from the main lower chamber and prevents gas from passing therethrough; and the airbag cushion further comprising: a first inner vent for supplying gas from the pre-upper chamber to the main upper chamber; and a check valve for supplying gas from the pre-lower chamber to the main lower chamber while preventing gas from passing from the main lower chamber to the pre-lower chamber.

The pre-push chamber is a portion that starts to expand and deploy before the main chamber. The pre-push chamber expands and deploys early to push the occupant back toward the center of the seat, and then the main chamber expands and deploys widely, thereby efficiently restraining the occupant.

In the configuration described above, the pre-lower chamber is expanded along the seat cushion, and the main lower chamber receives gas from the pre-lower chamber and expands and deploys. This main lower chamber is capable of restraining the waist region of an occupant seated on the seat cushion. In particular, since the main lower chamber has a check valve that prevents gas from flowing back into the pre-lower chamber, the internal pressure can be kept high and the heavy waist region can be fully restrained. Therefore, according to the configuration described above, with a simple configuration that utilizes a baffle and a check valve, the amount of movement of the occupant from the seat can be suppressed, and the occupant restraint performance of the airbag cushion can be improved.

The check valve may include a second inner vent penetrating a prescribed portion of a panel member that demarcates the pre-lower chamber and the main lower chamber, a patch attached to the panel member so as to cover the second inner vent in the main lower chamber, and a pair of joints provided at two locations facing each other with respect to the second inner vent and joining the panel member and the patch, and the patch can separate from the panel member in an area other than the pair of joints.

According to the configuration described above, a check valve that prevents gas from flowing back from the main lower chamber to the pre-lower chamber can be suitably achieved.

The check valve may include a second inner vent penetrating a prescribed portion of a panel member that demarcates the pre-lower chamber and the main lower chamber, a pair of patches attached to the panel member so as to cover the second inner vent in the main lower chamber, and a joint part that joins the panel member and the pair of patches, and the pair of patches may be attached to the panel member such that each of the pair of patches has a semicircular shape and straight sides of the patches overlap each other above the second inner vent.

According to the configuration described above, a check valve that prevents gas from flowing back from the main lower chamber to the pre-lower chamber can be suitably achieved.

The check valve may include a second inner vent penetrating a prescribed portion of a panel member that demarcates the pre-lower chamber and the main lower chamber, a cross-shaped bridge attached to the panel member so as to overlap the second inner vent, and a patch having a prescribed cut attached to the panel member so as to cover the second inner vent in the main lower chamber.

According to the configuration described above, a check valve that prevents gas from flowing back from the main lower chamber to the pre-lower chamber can be suitably achieved.

The check valve may include a second inner vent penetrating a prescribed portion of a panel member that demarcates the pre-lower chamber and the main lower chamber and a pair of patches attached to the panel member so as to cover the second inner vent in the main lower chamber, and the pair of patch members may each have a cross-shaped cut, and may be attached to the panel member in a state in which the patch members are overlapped with the centers of the cross-shaped cuts aligned and rotated so that parts other than the centers do not overlap.

According to the configuration described above, a check valve that prevents gas from flowing back from the main lower chamber to the pre-lower chamber can be suitably achieved.

The airbag cushion may further include a main panel that forms the pre-push chamber side of the main chamber, wherein the main panel includes an upper panel forming from the main upper chamber to a top part of the main lower chamber and a lower panel forming a lower part of the main lower chamber; and the check valve includes a sewn part formed by folding back a lower edge of the upper panel and an upper edge of the upper panel toward the main lower chamber and sewing them together in an upper and lower overlapping state and a non-sewn part formed in a part of the upper and lower overlapping area, where sewing is not performed.

According to the configuration described above, a check valve that prevents gas from flowing back from the main lower chamber to the pre-lower chamber can be suitably achieved.

The lower panel may have one or more pleats formed by folds in the non-sewn part.

The provision of the pleats creates space in the vicinity of the non-sewn parts of the lower panel, allowing gas to flow more efficiently.

The baffle demarcates between the upper main chamber and the lower main chamber and the baffle contains a notch part formed in an area overlapping with the inflator in a vicinity of a rear end portion of the baffle when viewed from a width direction of the vehicle seat.

According to the configuration described above, the baffle demarcates the upper main chamber and the lower main chamber, and a notch part is provided in the baffle to reduce the thickness of the rear part of the airbag cushion, enabling the airbag cushion to be smoothly expanded and deployed while in contact with the seat frame.

The baffle demarcates between the upper main chamber and the lower main chamber and the baffle contains a notch part formed in a prescribed area near a rear end portion of the baffle when viewed from a width direction of the vehicle seat, and the rear end portion of the baffle having the notch part is sewn along the sewn part that forms a rear edge of the main chamber in a state of being bent towards an upper side of the airbag cushion.

According to the configuration described above, by providing a notch part at the rear end portion of the baffle and sewing the rear end portion together with the sewn part at the rear edge of the main chamber, the thickness of the rear part of the airbag cushion is reduced, which enables the airbag cushion to be smoothly expanded and deployed while in contact with the seat frame.

### EFFECT OF THE INVENTION

The present invention can provide a vehicular side airbag device that is capable of improving occupant restraint performance with a simple configuration.

### BRIEF DESCRIPTION OF THE DRAWINGS

FIG. 1(a)-1(b) are diagrams depicting a vehicular side airbag device according to an embodiment of the present invention.

FIG. 2(a)-2(b) are diagrams independently depicting the airbag cushion of FIG. 1(b).

FIG. 3(a)-3(b) are various cross-sectional views of the airbag cushion of FIG. 2(b).

FIG. 4(a)-4(c) are diagrams depicting the check valve of FIG. 3(b).

FIG. 5(a)-5(b) are diagrams depicting the results of a performance test of the airbag cushion of the present embodiment.

FIG. 6(a)-6(c) are diagrams depicting a First Modified Example of the check valve of FIG. 4.

FIG. 7(a)-7(c) are diagrams depicting a Second Modified Example of the check valve of FIG. 4.

FIG. 8(a)-8(c) are diagrams depicting a Third Modified Example of the check valve of FIG. 4.

FIG. 9(a)-9(b) are diagrams depicting a Fourth Modified Example of the check valve of FIG. 4.

FIG. 10(a)-10(c) are diagrams depicting the lower panel of FIG. 9(b).

FIG. 11(a)-11(e) are diagrams depicting a process of forming the check valve of FIG. 9(a).

FIG. 12(a)-12(b) are diagrams depicting an example of a state in which the check valve in FIG. 11(c) activates.

FIG. 13(a)-13(b) are diagrams depicting a modified example of the baffle in FIG. 9.

### DETAILED DESCRIPTION

Preferred embodiments according to the present invention will hereinafter be described in detail with reference to the attached drawings. Dimensions, materials, other specific numerical values, and the like indicated in the embodiments are merely examples for ease of understanding of the invention and do not limit the present invention unless otherwise noted. Note that in the present specification and drawings, elements having essentially identical functions and configurations are labeled with identical symbols in order to omit redundant descriptions, and illustrations of elements not directly related to the present disclosure are omitted.

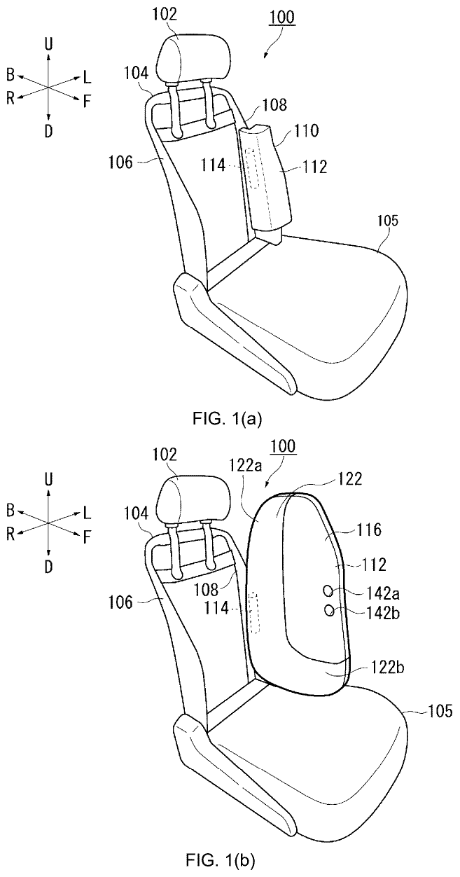

FIG. 1 is a diagram depicting the vehicular side airbag device (hereinafter, side airbag device 100) according to an embodiment of the present invention. FIG. 1(a) depicts an airbag cushion 112 prior to activation. The side airbag device 100 can be installed in any seat of the front row, rear row, or even on either the left or right side of the vehicle.

In the present embodiment, when an occupant is sitting in a vehicle seat 102 with a regular posture, the direction the occupant is facing is defined as forward, the opposite direction is backward, the right hand side of the occupant is the right direction and the left hand side of the occupant is the left direction. Furthermore, when the occupant is seated in a regular posture, the direction towards the head of the occupant is referred to as up, and the direction towards the legs of the occupant is referred to as down. In the drawings used in the description below, as necessary, the front, back, left, right, up, and down directions with reference to the occupant in a regular position described above are indicated by arrows F (Forward), B (Back), L (Left), R (Right), U (up), and D (down).

In FIG. 1(a), the skin or seat pad (for example, urethane material) of the seatback 104 of the seat 102 is omitted, and only a seat frame 106 is illustrated. The seat frame 106 is a skeletal structure member equipped in the seatback 104.

An airbag module 110 is attached to the side frame 108 of the seat frame 106. A side frame 108 is a part of the seat frame 106 that extends along the left and right side surfaces of the seat back 104.

In the present embodiment, the airbag module 110 is attached to the side frame 108 on the left side in the width direction of the seat back 104. However, the airbag module 110 can also be attached to the side frame on the right side in the width direction of the seat back 104. In other words, the airbag module 110 can be installed either on a side part on a door side (near side) of the seat 102 that is closer to a collision point, or on a side part on a vehicle inner side (far side) that is farther from the collision point.

The airbag module 110 includes an airbag cushion 112 and an inflator 114. The airbag cushion 112 is a bag-shaped member that can be expanded with gas, and is attached to the side frame in a prescribed storage configuration by being rolled or folded. The airbag cushion expands and deploys in the event of an emergency, such as when an impact occurs to the vehicle, to restrain an occupant seated in the seat 102.

The inflator 114 is a gas generating device that is electrically connected to a vehicle side that activates upon receiving a signal originating from the vehicle side detecting an impact, and that supplies gas to the airbag cushion 112. In the present embodiment, the inflator 114 used is a cylinder type. The inflator 114 is attached to the side frame 108 using a stud bolt (not depicted) in a state where the inflator is inserted into the airbag cushion 112 with the longitudinal direction thereof extending vertically along the side frame 108.

Examples of currently prevailing inflators include: types which are filled with a gas generating agent and burn the agent to generate gas; types which are filled with compressed gas and supply gas without generating heat; hybrid types which utilize both combustion gas and compressed gas; and the like. Any of these types can be used for the inflator 114.

FIG. 1(b) is a diagram depicting a state after expansion and deployment of the airbag cushion 112 of FIG. 1(a). When the side airbag device 100 detects a collision via various sensors and a prescribed Electronic Control Unit (ECU), the airbag device activates the airbag module 110.

The inflator 114 ejects gas based on an activation signal sent from the ECU described above or the like. The airbag cushion 112 pushes the skin of the seat back 104 out of the way and expands and deploys into the cabin space by using gas from the inflator 114.

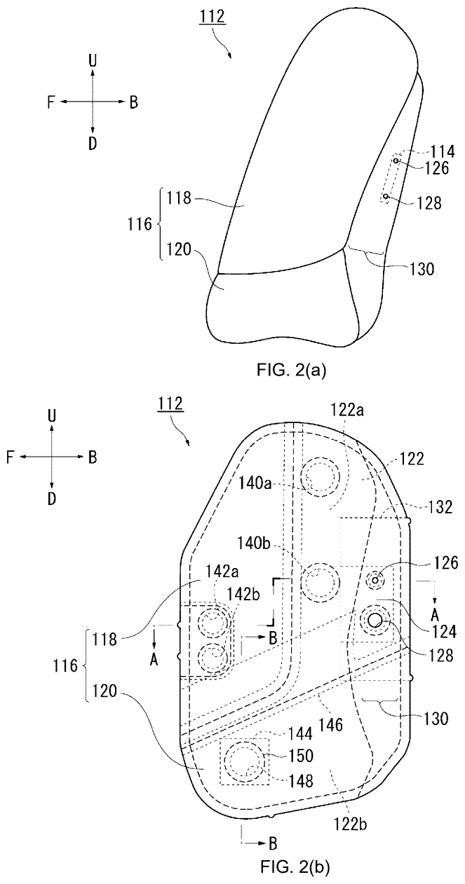

FIG. 2 is a diagram independently depicting the airbag cushion 112 of FIG. 1(b). FIG. 2(a) is a diagram depicting the airbag cushion 112 of FIG. 1(b) as viewed from the outside in the width direction of the seat.

The airbag cushion 112 of the present embodiment includes a main chamber 116 as a main portion for restraining an occupant. The main chamber 116 is a portion that expands and deploys widely forward from the side frame 108 (see FIG. 1(b)). The inside of the main chamber 116 is divided by a baffle 146, described below, into an upper main chamber 118 which primarily restrains the shoulders and chest of the occupant, and a lower main chamber 120 which primarily restrains the waist of the occupant.

The airbag cushion 112 includes a pre-push chamber 122 that is expanded and deployed prior to the main chamber 116. As shown in FIG. 1(b), the pre-push chamber 122 expands and deploys, protruding from the rear side of the main chamber 116 toward the center side in the width direction of the seat back 104.

The pre-push chamber 122 receives gas from the inflator 114 first and rapidly expands and deploys, pushing the occupant back toward the center of the seat 102. Furthermore, the main chamber 116 receives the gas that has passed through the pre-push chamber 122 and inflates to widely restrain the body of the occupant.

FIG. 2(b) is a diagram illustrating the configuration of a panel member of the airbag cushion 112 of FIG. 2(b). The airbag cushion 112 is a bag shaped member formed by overlapping and sewing or adhering a plurality of base materials configuring a front surface thereof, by spinning and weaving using an OPW (one-piece woven), or the like.

An inflator insertion part 124 is provided at a portion that becomes the rear side when the airbag cushion 112 is unfolded. The inflator insertion part 124 is a portion into which the inflator 114 (see FIG. 2(a)) is inserted and installed, and is provided at a position inside the pre-push chamber 122 that is behind the main chamber 116.

The inflator insertion part 124 is provided with bolt holes 126, 128 through which two stud bolts provided on the inflator 114 (see FIG. 2(a)) pass. The stud bolts are exposed to the outside through bolt holes 126, 128 and are fastened to the side frame 108 (see FIG. 1(b)). This also attaches the airbag cushion 112 to the side frame 108.

Note that while the inflator insertion part 124 is assumed to be configured so that the stud bolt is fastened to the side frame 108 from the center side of the seat 102, the stud bolt can also be fastened to the side frame 108 from the outside.

A frame ground part 130 is formed behind the main chamber 116. The frame ground part 130 is a portion of the pre-push chamber 122 located on the outer side in the width direction. The frame ground part 130 is provided in a shape that conforms to the side frame 108 (see FIG. 1B) so that the pre-push chamber 122 receives a reaction force from the side frame 108.

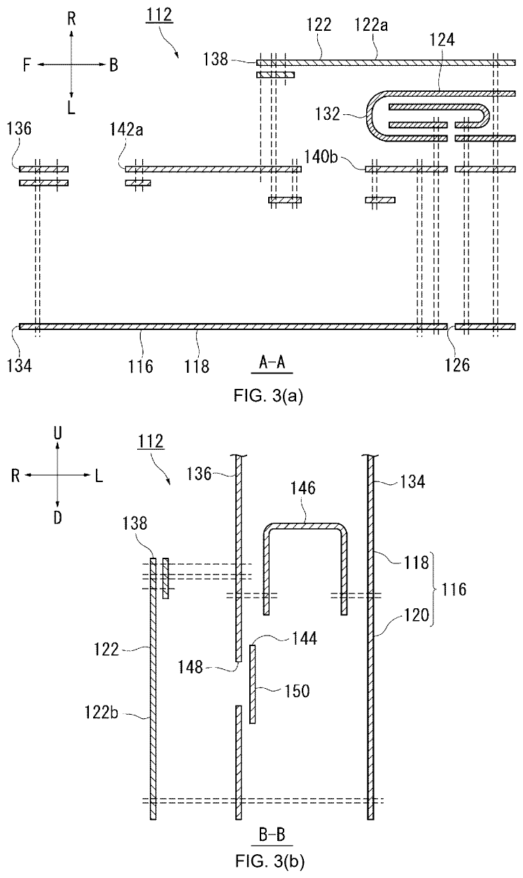

FIG. 3 provides various cross-sectional views of the airbag cushion 112 of FIG. 2(b). FIG. 3(a) is a cross-sectional view along A-A of the airbag cushion 112 of FIG. 2(b). The main chamber 116 is configured to include, as panel members, a main panel 134 on the outer side in the width direction of the seat 102 (see FIG. 1(a)) and a main panel 136 on the center side in the width direction of the seat 102. The pre-push chamber 122 is formed by providing a panel member 138 on a main panel 136 of the main chamber 116.

As mentioned above, the pre-push chamber 122 is provided with an inflator insertion part 124. The inflator insertion part 124 includes an inner tube 132 that streamlines the gas flow in the vertical direction. The inflator insertion part 124 is attached to the side frame 108 (see FIG. 1B) from the center side in the width direction of the seat back 104, with the stud bolts of the inflator 114 exposed to the outside through the bolt holes 126 or the like.

The pre-push chamber 122 is supplied with gas from the inflator 114 (see FIG. 2(a)) early on, and completes expansion and deployment rapidly prior to the main chamber 116 doing so. The pre-push chamber 122 pushes the occupant back toward the center of the seat 102 while pushing aside the seat pad and the like inside the seat 102 (see FIG. 1(a)) to ensure space for the main chamber to expand and deploy.

As depicted in FIG. 1(b), the pre-push chamber 122 is L-shaped and extends from the rear to the lower part of the airbag cushion 112. Of the pre-push chamber 122, the pre-upper chamber 122a extends in the up-down direction along the seat back 104. A pre-lower chamber 122b extends forward from the lower part of the pre-upper chamber 122a along a seat cushion 105 of the seat 102.

In the main chamber 116 of FIG. 2(b), the main upper chamber 118 is provided in an area that overlaps with the pre-upper chamber 122a when the seat 102 is viewed from the side. The main upper chamber 118 is connected to the pre-upper chamber 122a by first inner vents 140a, 140b.

As shown in FIG. 3(a), the main upper chamber 118 is supplied with gas from the inflator 114 (see FIG. 2(a)) from the pre-upper chamber 122a through the first inner vent 140b. Vent holes 142a and 142b are provided at the front of the main upper chamber 118, and gas that expands and deploys the main upper chamber 118 is discharged to the outside through the vent holes 142a and 142b.

FIG. 3(b) is a cross-sectional view along B-B of the airbag cushion 112 of FIG. 2(b). The main lower chamber 120 is provided below the main upper chamber 118 in an area overlapping with the pre-lower chamber 122b. The main lower chamber 120 receives gas from the pre-lower chamber 122b through a check valve 144, and restrains mainly the waist region of the occupant.

A baffle 146 is provided inside the main chamber 116. The baffle 146 is a panel member composed of the same base fabric as the main panel 134, and is joined to the main panels 134, 136 by sewing. The baffle 146 demarcates the main chamber 116 into a main upper chamber 118 and a main lower chamber 120, and gas cannot pass between the main upper chamber 118 and the main lower chamber 120.

Note that the baffle 146 may also be sewn to the main panel 136 together with the panel member 138. Also, although the baffle 146 is arranged so that the folds are located on the upper side in FIG. 3(b), arranging such that the folds are located on the lower side is also feasible. Furthermore, as an alternative to the baffle 146, the interior of the main chamber 116 can also be demarcated into a main upper chamber 118 and a main lower chamber 120 by joining the main panels 134, 136 in the same area as the baffle 146 is joined.

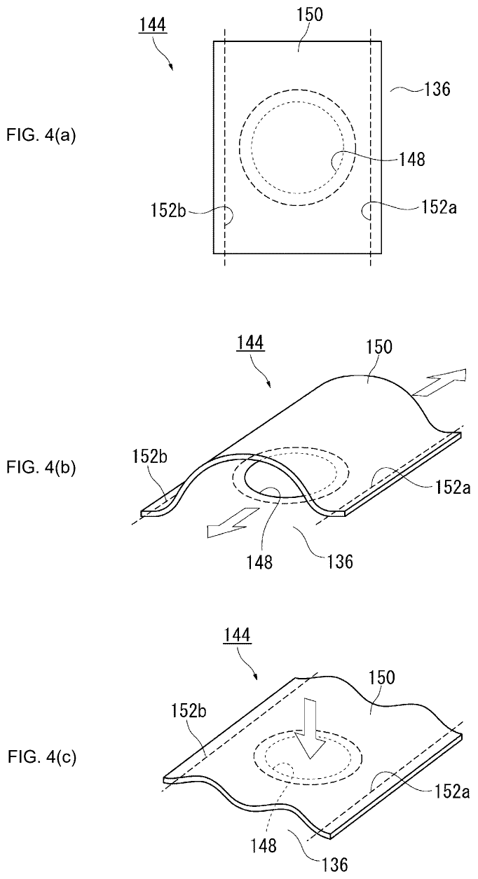

FIG. 4 is a diagram depicting the check valve 144 of FIG. 3(b). FIG. 4(a) is a diagram depicting an overview of the check valve 144. The check valve 144 is capable of supplying gas from the pre-lower chamber 122b (see FIG. 3(b)) to the main lower chamber 120 while preventing gas from passing from the main lower chamber 120 to the pre-lower chamber 122b.

The check valve 144 is composed of a second inner vent 148 provided in the main panel 136, a patch 150 covering the second inner vent 148, and a pair of joints 152a, 152b.

The second inner vent 148 is a location through which gas passes, and is provided as a through-hole penetrating the main panel 136 that separates the pre-lower chamber 122b (see FIG. 3(b)) and the main lower chamber 120.

The patch 150 is attached to the main panel 136 so as to cover the second inner vent 148 on the main lower chamber 120 side (see FIG. 3(b)) of the main panel 136.

The pair of joints 152a, 152b are portions that join the main panel 136 and the patch 150, and are provided at two locations that face each other with the second inner vent 148 at the center. In the present embodiment, the joints 152a, 152b are achieved by stitching along the right and left edges of the patch 150.

FIG. 4(b) is a diagram depicting a state in which the check valve 144 in FIG. 4(a) is open. The distance between the joints 152a, 152b is shorter than the dimensions of the upper and lower edges of the patch 150, so that a slack is formed in the patch 150. Therefore, when gas force is applied from the pre-lower chamber 122b side, the patch 150 moves away from the main panel 136 toward the main lower chamber 120 side, allowing gas to flow vertically from the upper and lower edges.

In addition, as another aspect of the patch 150, the joints 152a, 152b may be provided as a single continuous piece. For example, stitching may be provided from the upper edge to the left and right edges of the patch 150, with only the lower edge of the patch 150 being not sewn. With this configuration, a check valve that allows gas to flow only downward can be achieved.

FIG. 4(c) is a diagram depicting a state in which the check valve 144 in FIG. 4(a) is closed. When external pressure is applied to the main lower chamber 120 during passenger restraint, the force of the gas in the main lower chamber 120 presses the patch 150 against the main panel 136, causing the second inner vent 148 to become blocked. Therefore, the backflow of gas from inside the main lower chamber 120 is suppressed, and the internal pressure of the main lower chamber 120 is maintained.

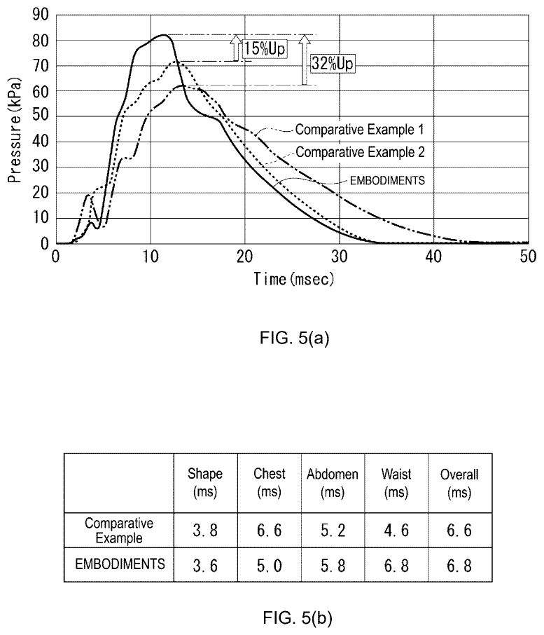

FIG. 5 is a diagram depicting the results of a performance test of the airbag cushion 112 of the present embodiment. FIG. 5(a) is a diagram depicting the results of an internal pressure test of the airbag cushion 112.

In FIG. 5(a), the horizontal axis indicates time (msec), and the vertical axis indicates internal pressure (kPa). The embodiment is an example of the airbag cushion 112 described above, which includes a pre-push chamber 122, a main chamber 116 divided into a main upper chamber 118 and a main lower chamber 120 by a baffle 146, and a check valve 144 provided in the main lower chamber 120.

Comparative Example 1 is an example that includes a pre-push chamber 122 (see FIG. 3(b)) and a main chamber that does not have a baffle 146 and has an undivided interior. Comparative Example 2 is an example including a pre-push chamber 122 and a main chamber 116 whose interior is divided into an upper part and a lower part by a baffle 146. Neither Comparative Example 1 nor Comparative Example 2 has a check valve 144.

This test involved measuring the internal pressure in the area that restrains the occupant's waist region. As a result, as illustrated in FIG. 5(a), the airbag cushion 112 of the present embodiment was found to be able to maintain a higher internal pressure in the main lower chamber 120 that restrains the waist region compared to Comparative Example 1 and Comparative Example 2 by having the check valve 144.

FIG. 5(b) is a diagram depicting the results of a static deployment test of the airbag cushion 112. This test was carried out to analyze the speed at which each area of the airbag cushion 112 completed expansion and deployment. The comparative example is an example of an airbag cushion for a conventional side airbag that does not include the pre-push chamber 122 (see FIG. 3(b)) or the baffle 146.

As depicted in FIG. 5(b), the airbag cushion 112 of the present embodiment was found to rapidly complete expansion and deployment, particularly in the area that restrains the waist region. Therefore, the flow of gas was found to be adjusted by the pre-push chamber 122 (see FIG. 3(b)) and the baffle 146, and the main lower chamber 120 that restrains the waist region can be rapidly inflated and deployed.

As described above, with the airbag cushion 112 (see FIG. 1(b)) of the present embodiment, the pre-lower chamber 122b expands along the seat cushion 105, and the main lower chamber 120 (see FIG. 3(b)) expands and deploys by receiving gas from the pre-lower chamber 122b, and the check valve 144 prevents gas from flowing back from the main lower chamber 120 to the pre-lower chamber 122b. Therefore, the airbag cushion 112 can achieve more rapid expansion and deployment of the main lower chamber 120 and maintain a high internal pressure, enabling fully restraining the heavy waist region. Therefore, according to the present embodiment, with a simple configuration using the baffle 146 and the check valve 144, the amount of movement of the occupant from the seat 102 can be suppressed; enabling improvement in the occupant restraint performance of the airbag cushion 112.

### Modified Example Airbag Cushion

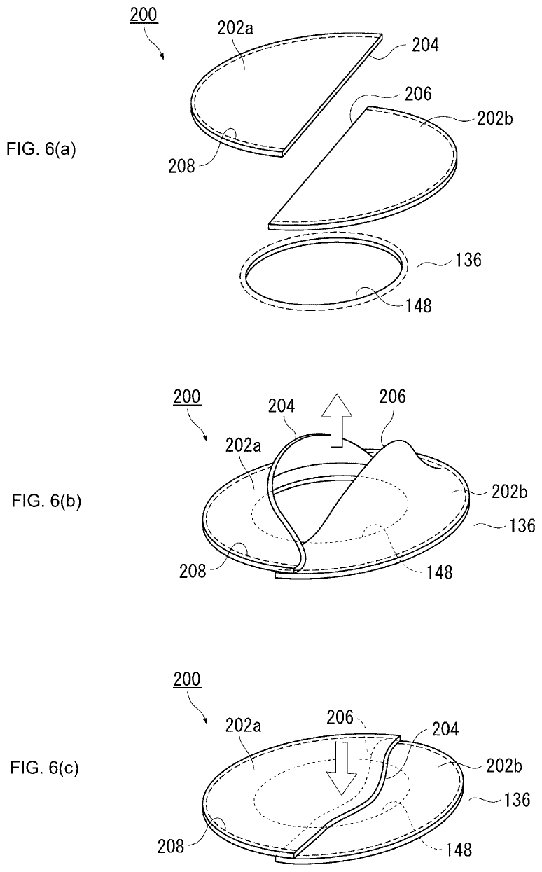

FIG. 6 is a diagram depicting the First Modified Example (check valve 200) of the check valve 144 of FIG. 4. In the description below, the same code will be provided for configuration elements that have already been described and the description thereof is omitted. In addition, configuration elements with the same name as configuration elements already described have the same configuration and function even if a different reference is applied.

FIG. 6(a) is a diagram depicting an overview of the check valve 200. The check valve 200 is achieved by the second inner vent 148 and a pair of patches 202a, 202b attached to the main panel 136 so as to cover the second inner vent 148 in the main lower chamber 120 (see FIG. 3(b)).

The patches 202a, 202b are each semicircular and attached to the main panel 136 on the main lower chamber 120 side (see FIG. 3(b)) of the main panel 136 such that the straight sides 204, 206 overlap each other above the second inner vent 148.

The joints 208 are provided as stitching along the arc of the semicircular patches 202a, 202b, joining the patches 202a, 202b to the main panel 136.

FIG. 6(b) is a diagram depicting a state in which the check valve 200 in FIG. 6(a) is open. The patches 202a, 202b are attached to the main panel 136 with some slack. Furthermore, when gas force is applied from the pre-lower chamber 122b side (see FIG. 3(b)), the straight sides 204, 206 of the patches 202a, 202b move away from the main panel 136 toward the main lower chamber 120, and an opening is formed between the straight sides 204, 206, allowing gas to pass through.

FIG. 6(c) is a diagram depicting a state in which the check valve 200 in FIG. 6(a) is closed. When external pressure is applied to the main lower chamber 120 (see FIG. 3(b)) during passenger restraint, the force of the gas in the main lower chamber 120 presses the patches 202a, 202b against the main panel 136, causing the second inner vent 148 to become blocked. Therefore, the check valve 200 also enables preventing backflow of gas from inside the main lower chamber 120 and maintaining the internal pressure of the main lower chamber 120.

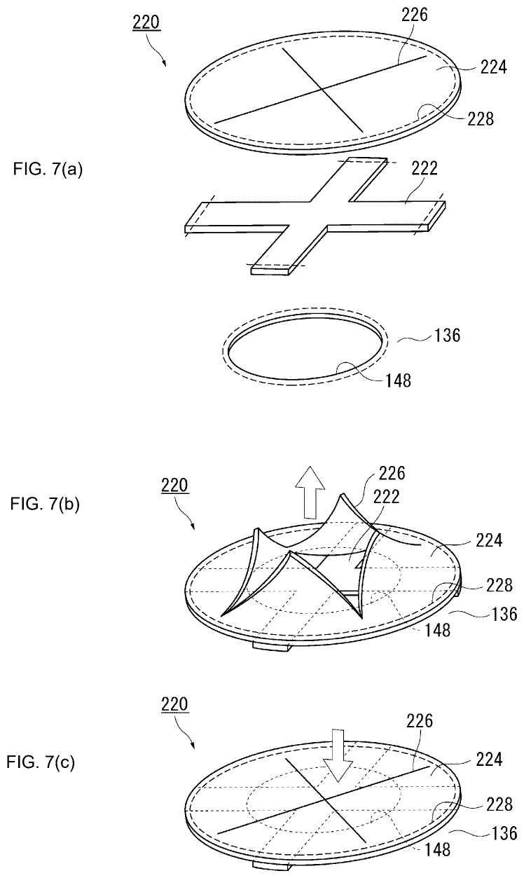

FIG. 7 is a diagram depicting the Second Modified Example (check valve 220) of the check valve 144 of FIG. 4. FIG. 7(a) is a diagram depicting an overview of the check valve 220. The check valve 220 is achieved by the second inner vent 148, a cross-shaped bridge 222 attached to the main panel 136 overlapping the second inner vent 148, and a patch 224 attached to the main panel 136 for covering the second inner vent 148 in the main lower chamber 120 (see FIG. 3(b)).

The bridge 222 is a member that prevents the patch 224 from moving toward the pre-lower chamber 122b (see FIG. 3(b)), and is attached by overlapping with the second inner vent 148 and sewing each end of the cross shape to the main panel 136.

The patch 224 is circular and has a cross-shaped cut 226. The patch 224 is attached to the main panel 136 so as to cover the second inner vent 148 on the main lower chamber 120 side (see FIG. 3(b)) of the main panel. A joint 228 is provided around the periphery of the patch 224 and bonds the patch 224 to the main panel 136.

FIG. 7(b) is a diagram depicting a state in which the check valve 220 in FIG. 7(a) is open. When gas force is applied from the pre-lower chamber 122b side (see FIG. 3(b)), the cross-shaped cut 226 of the patch 224 opens to form an opening through which the gas can pass.

FIG. 7(c) is a diagram depicting a state in which the check valve 220 in FIG. 7(a) is closed. When external pressure is applied to the main lower chamber 120 during occupant restraint, the force of the gas in the main lower chamber 120 presses the patch 224 against the bridge 222, the cross cut 226 does not open, and in addition, the second inner vent 148 is blocked. Therefore, the check valve 220 also enables preventing backflow of gas from inside the main lower chamber 120 (see FIG. 3(b)) and maintaining the internal pressure of the main lower chamber 120.

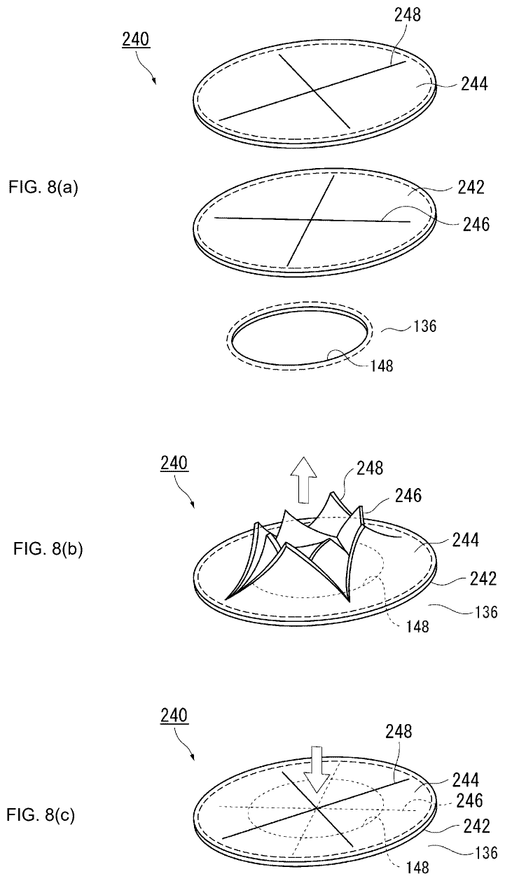

FIG. 8 is a diagram depicting the Third Modified Example (check valve 240) of the check valve 144 of FIG. 4. FIG. 8(a) is a diagram depicting an overview of the check valve. The check valve 240 is achieved by the second inner vent 148 and a pair of patches 242, 244 attached to the main panel 136 so as to cover the second inner vent 148 in the main lower chamber 120 (see FIG. 3(b)).

Patches 242, 244 each have circular cross-shaped cuts 246, 248, respectively. The patches 242, 244 are attached to the main panel 136 with the cross-shaped cuts 246, 248 aligned and overlapping, but rotated so that the rest of the patches do not overlap.

FIG. 8(b) is a diagram depicting a state in which the check valve 240 in FIG. 8(a) is open. When a large gas force is applied from the pre-lower chamber 122b side (see FIG. 3(b)) due to the activation of the inflator 114 (see FIG. 2(a)), the cross-shaped cuts 246, 248 of the patches 242, 244 open to form openings to allow the gas to pass through.

FIG. 8(c) is a diagram depicting a state in which the check valve 240 in FIG. 8(a) is closed. The patches 242, 244 do not readily open by the force exerted when an occupant is restrained, which is smaller than the force exerted when the inflator 114 (see FIG. 2(a)) activates, and are maintained in a state in which the second inner vent 148 is closed. Therefore, the check valve 240 also enables preventing backflow of gas from inside the main lower chamber 120 (see FIG. 3(b)) and maintaining the internal pressure of the main lower chamber 120.

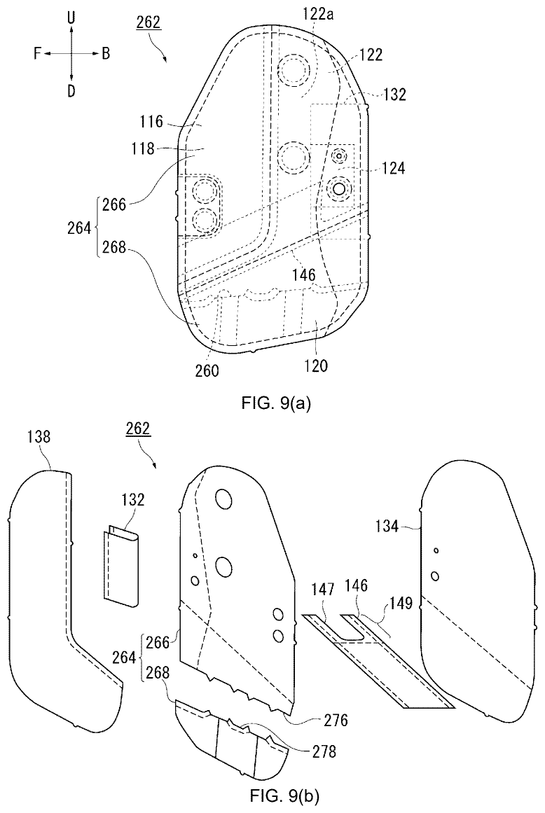

FIG. 9 is a diagram depicting the Fourth Modified Example (check valve 260) of the check valve 144 of FIG. 4. FIG. 9(a) is a diagram depicting the check valve 260 corresponding to FIG. 2(b).

The airbag cushion 262 having the check valve 260 has a main panel 264 that forms the pre-push chamber 122 side of the main chamber 116 and is composed of an upper panel 266 and a lower panel 268. Furthermore, a part between the upper panel 266 and the lower panel 268 is openable, and this part functions as the check valve 260.

FIG. 9B is an exploded view of each panel member of the airbag cushion 262 of FIG. 9(a). As depicted in FIG. 9(b), the main chamber 116 is formed by an outer main panel 134 in the width direction of the seat 102 (see FIG. 1(b)) and an inner main panel 264, with a baffle 146 disposed therebetween. The panel member 138 of the pre-push chamber 122 is attached further inside the main panel 264, and the inner tube 132 is disposed inside.

Of the main panels 264, an upper panel 266 forms the area from the main upper chamber 118 (see FIG. 9(a)) to the top of the main lower chamber 120. The lower panel 268 forms the lower part of the main lower chamber 120.

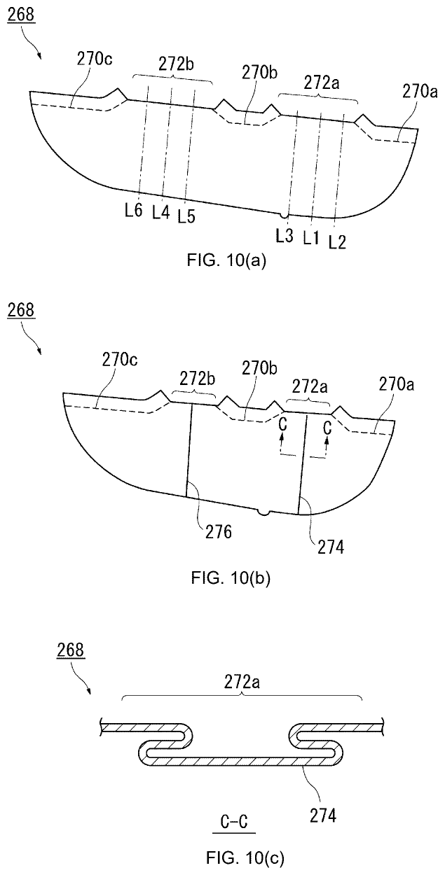

FIG. 10 is a diagram depicting the lower panel 268 of FIG. 9(b). FIG. 10(a) is a diagram showing the lower panel 268 of FIG. 9(a) laid out on a flat surface. The lower panel 268 is configured such that sewn parts 270a to 270c are joined to the lower panel 268 (see FIG. 9(b)), and the non-sewn parts 272a, 272b form openings through which gas can pass.

The lower panel 268 is formed with pleats 274, 276 (see FIG. 10(b)) in order to open the non-sewn portions 272a, 272b widely. The pleats 274, 276 are provided by forming folds in the non-sewn parts 272a, 272b. For example, the non-sewn part 272a has a valley fold L1 and ridge folds L2 and L3 formed therein. Similarly, a valley fold L4 and ridge folds L5 and L6 are formed in the non-sewn portion 272b.

FIG. 10(b) is a diagram of pleats 274, 276 having been provided on the lower panel 268 of FIG. 10(a). Providing of the pleats 274, 276, reduces the size of the lower panel 268.

FIG. 10(c) is a cross-sectional view along C-C of FIG. 10(b). As depicted in FIG. 10(c), the pleats 274 are provided so that the non-sewn part 272a is in a folded state.

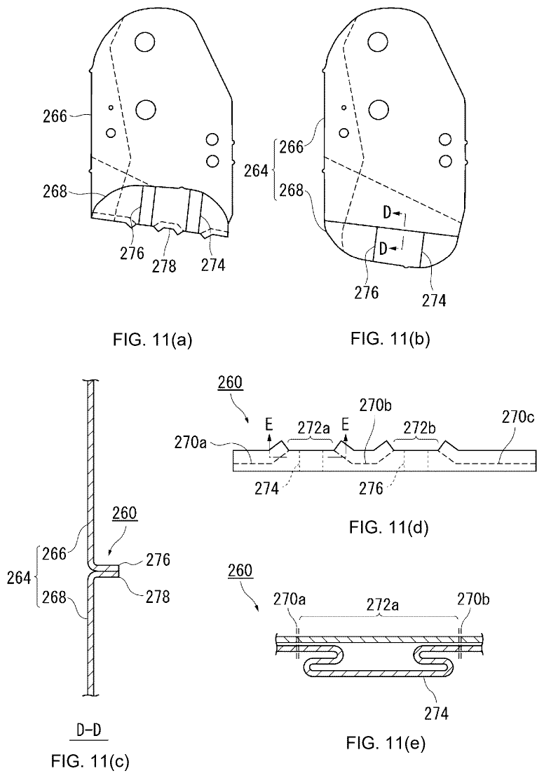

FIG. 11 is a diagram depicting a process of forming the check valve 260 of FIG. 9(a). FIG. 11(a) depicts the lower panel 268 of FIG. 10(b) joined to the upper panel 266 of FIG. 9(b). The lower panel 268 is turned upside down, and then an upper edge 278 is superimposed on a lower edge 276 (see FIG. 9(b)) of the upper panel 266 and joined thereto.

FIG. 11(b) is a diagram of the lower panel 268 of FIG. 11(a) turned down again. The main panel 264 is formed by inverting the lower panel 268 joined to the upper panel 266.

FIG. 11(c) is a cross-sectional view of the main panel 264 taken along the line D-D of FIG. 11(b). The check valve 260 is configured such that a lower edge 276 of the upper panel 266 and an upper edge 278 of the upper panel 266 are folded back toward the main lower chamber 120 (see FIG. 3B) and overlap each other.

FIG. 11(d) is a view of the check valve 260 in FIG. 11(c) as viewed from the outside in the width direction of the seat (the right side in FIG. 11(c)), depicting the check valve 260 from the same direction as FIG. 9(a). The check valve 260 is provided by overlapping and sewing the lower edge 276 of the upper panel 266 and the upper edge 278 of the lower panel 268 together to form sewn parts 270a to 270c, and by forming non-sewn parts 272a, 272b in a partial area where no sewing is applied.

FIG. 11(e) is a cross-sectional view of E-E of the check valve 260 in FIG. 11(d). As described above, pleats 274 are formed by forming folds in the non-sewn part 272a.

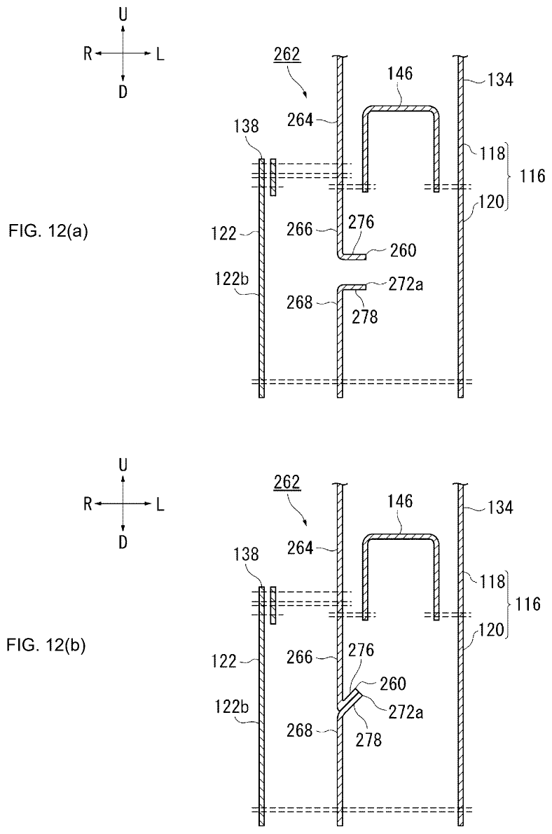

FIG. 12 is a diagram depicting an example of a state in which the check valve 260 in FIG. 11(c) activates. FIG. 12(a) is a diagram depicting a state in which the check valve 260 in FIG. 11(c) is open. The lower panel 268 has pleats 274 near the non-sewn parts 272a, 272b to provide extra space. Therefore, the non-sewn parts 272a, 272b open when gas force is applied from the pre-lower chamber 122b side, allowing the gas to flow efficiently.

FIG. 12(b) is a diagram depicting a state in which the check valve 260 in FIG. 12(a) is closed. When external pressure is applied to the main lower chamber 120 during passenger restraint, the force of the gas in the lower main chamber 120 presses the check valve 260 against the main panel 264, and the non-sewn part 272a does not open. Therefore, the check valve 260 also enables preventing backflow of gas from inside the main lower chamber 120 and maintaining the internal pressure of the main lower chamber 120.

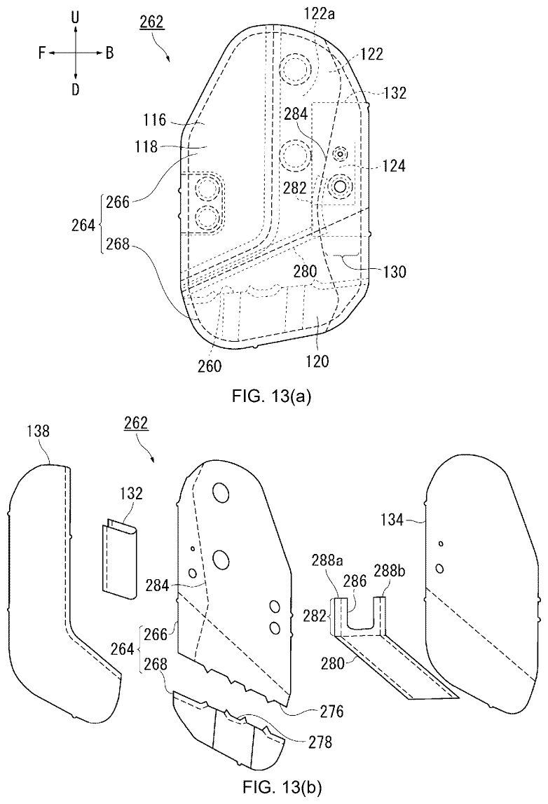

FIG. 13 is a diagram depicting a modified example (baffle 280) of the baffle 146 depicted in FIG. 9. FIG. 13(a) is a diagram depicting the baffle 280 according to FIG. 9(a).

The baffle 280 is installed in a state in which a rear end portion 282 is bent upward along a sewn part 284 that borders the front side of the frame ground part 130 of the main chamber 116.

Here, the baffle 146 in FIG. 9(b) is provided with a notch 147. A notch part 147 is formed by cutting out an area that overlaps with the inflator 114 (see FIG. 2(a)) near a rear end portion 149 of the baffle 146 when viewed in the width direction of the seat (see FIG. 1(b)). By providing the notch part 147 in the baffle 146, the thickness of the rear part of the airbag cushion 112 can be suppressed, and the airbag cushion 112 can be smoothly expanded and deployed while in contact with the seat frame 106.

FIG. 13(b) is a diagram depicting the baffle 280 according to FIG. 9(b). The rear end portion 282 of the baffle 280 has a notch part 286 formed in the center as well as bifurcated edge parts 288a, 288b.

The rear end portion 282 of the baffle 280, including the notch part 286, is bent upward toward the airbag cushion 262 and sewn along a sewn part 284 that forms the rear edge of the main chamber 116 (see FIG. 13(a)). Side edges 288a, 288b have an elongated shape and do not expand after being overlapped and sewn along the sewn part 284, so that the thickness of the airbag cushion 262 when expanded and deployed can be reduced.

As described above, by bending the rear end portion 282 of the baffle 280 upward and sewing the rear end portion to the sewn part 284, the thickness of the rear side of the airbag cushion 262 can be suppressed and the frame grounding part 130 (see FIG. 13(a)) can be suitably formed. Therefore, the airbag cushion 262 equipped with the baffle 280 can be smoothly expanded and deployed while in contact with the seat frame 106 (see FIG. 1(b)).

Preferred examples of the present invention were described above while referring to the attached drawings. However, the embodiments described above are preferred examples of the present invention, and other embodiments can be implemented or performed by various methods. In particular, unless described otherwise in the specification of the present application, the invention is not limited to the shape, size, configurational disposition, and the like of parts illustrated in detail in the attached drawings. Furthermore, expressions and terms used in the specification of the present application are used for providing a description, and the disclosure is not limited thereto, unless specifically described otherwise.

Therefore, a person of ordinary skill in the art could obviously conceive of various changed examples or modified examples within the scope described in the scope of the claims, which is understood to naturally belong to the technical scope of the present invention.

### Industrial Applicability

The present invention can be used in a vehicular side airbag device.

### EXPLANATION OF CODES

100. Side airbag device,
102. Seat,
104. Seatback,
105. Seat cushion,
106. Seat frame,
108. Side frame,
110. Airbag module,
112. Airbag cushion,
114. Inflator,
116. Main chamber,
118. Upper main chamber,
120. Lower main chamber,
122. Pre-push chamber,
122a. Pre-upper chamber,
122b. Pre-lower chamber,
124. Inflator insertion part,
126. Bolt hole,
130. Frame ground part,
132. Inner tube,
134. Main panel,
136. Main panel,
138. Panel member,
140a, 140b. First inner vent,
142a, 142b. Vent hole,
144. Check valve,
146. Baffle,
147. Notch part,
148. Second inner vent,
149. Rear end portion,
150. Patch, 152a, 152b. Joint,
200. Check valve,
202a, 202b. Patch,
204, 206. Straight side,
208. Joint,
220. Check valve,
222. Bridge,
224. Patch,
226. Notch,
228. Joint,
240. Check valve,
242, 244. Patch,
246, 248. Notch,
260. Check valve,
262. Airbag cushion,
264. Main panel,
266. Upper panel,
268. Lower panel,
270a to 270c. Sewn part,
272a, 272b. Non-sewn part,
274. Pleats,
276. Lower edge,
278. Upper edge,
280. Baffle,
282. Rear end portion,
284. Sewn part,
286. Notch part,
288a, 288b. Side edges.

1. A vehicular side airbag device having an airbag module that can be attached in a side frame of a seat back of a vehicle seat,
the airbag module comprising:
an airbag cushion that is rolled or folded in a prescribed storage form and attached in the side frame; and
an inflator attached to the side frame in a state of being inserted into the airbag cushion;
the airbag cushion comprising:
a pre-push chamber which is the first to receive gas from the inflator and expands and deploys; and
a main chamber that receives gas passing through the pre-push chamber and expands and deploys;
the pre-push chamber comprising:
a pre-upper chamber extending in a vertical direction along the seat back; and
a pre-lower chamber extending forward from a lower part of the pre-upper chamber along a seat cushion of the vehicle seat;
the main chamber comprising:
a main upper chamber provided in an area overlapping the pre-upper chamber as viewed from a side of the vehicle seat;
a main lower chamber provided below the main upper chamber in an area overlapping the pre-lower chamber; and
a baffle or stitching that partitions the main upper chamber from the main lower chamber and prevents gas from passing therethrough; and
the airbag cushion further comprising:
a first inner vent for supplying gas from the pre-upper chamber to the main upper chamber; and
a check valve for supplying gas from the pre-lower chamber to the main lower chamber while preventing gas from passing from the main lower chamber to the pre-lower chamber.

2. The vehicular side airbag device according to claim 1, wherein
the check valve includes:
a second inner vent penetrating a prescribed portion of a panel member that demarcates the pre-lower chamber and the main lower chamber;
a patch attached to the panel member so as to cover the second inner vent in the main lower chamber; and
a pair of joints provided at two locations facing each other with respect to the second inner vent and joining the panel member and the patch; and
the patch can separate from the panel member in an area other than the pair of joints.

3. The vehicle side airbag device according to claim 1, wherein
the check valve includes:
a second inner vent penetrating a prescribed portion of a panel member that demarcates the pre-lower chamber and the main lower chamber;
a pair of patches attached to the panel member so as to cover the second inner vent in the main lower chamber; and
a joint part that joins the panel member and the pair of patches; and
the pair of patches are attached to the panel member such that each of the pair of patches has a semicircular shape and straight sides of the patches overlap each other above the second inner vent.

4. The side airbag device for a vehicle according to claim 1,
the check valve comprising:
a second inner vent penetrating a prescribed portion of a panel member that demarcates the pre-lower chamber and the main lower chamber;
a cross-shaped bridge attached to the panel member so as to overlap the second inner vent; and
a patch having a prescribed cut attached to the panel member so as to cover the second inner vent in the main lower chamber.

5. The vehicle side airbag device according to claim 1, wherein
the check valve includes:
a second inner vent penetrating a prescribed portion of a panel member that demarcates the pre-lower chamber and the main lower chamber; and
a pair of patches attached to the panel member so as to cover the second inner vent in the main lower chamber; and
the pair of patch members each have a cross-shaped cut, and are attached to the panel member in a state in which the patch members are overlapped with the centers of the cross-shaped cuts aligned and rotated so that parts other than the centers do not overlap.

6. The side airbag device for a vehicle according to claim 1, wherein
the airbag cushion further includes a main panel that forms the pre-push chamber side of the main chamber;
the main panel includes:
an upper panel forming from the main upper chamber to a top part of the main lower chamber; and
a lower panel forming a lower part of the main lower chamber; and
the check valve includes:
a sewn part formed by folding back a lower edge of the upper panel and an upper edge of the upper panel toward the main lower chamber and sewing them together in an upper and lower overlapping state; and
a non-sewn part formed in a part of the upper and lower overlapping area, where sewing is not performed.

7. The vehicular side airbag device according to claim 6, wherein the lower panel includes one or more pleats provided by forming folds in the non-sewn part.

8. The vehicular side airbag device according to claim 1, wherein the baffle demarcates between the upper main chamber and the lower main chamber, the baffle containing a notch part formed in an area overlapping with the inflator in a vicinity of a rear end portion of the baffle when viewed from a width direction of the vehicle seat.

9. The vehicular side airbag device according to claim 1, wherein the baffle demarcates between the upper main chamber and the lower main chamber, the baffle containing a notch part formed in a prescribed area near a rear end portion of the baffle when viewed from a width direction of the vehicle seat, and the rear end portion of the baffle having the notch part is sewn along the sewn part that forms a rear edge of the main chamber in a state of being bent towards an upper side of the airbag cushion.
